(19) United States
(12) Patent Application Publication
(10) Pub. No.: US 2018/0053465 A1
(43) Pub. Date: Feb. 22, 2018

(54) METHOD, NON-TRANSITORY COMPUTER-READABLE MEDIUM AND RELATED ELECTRONIC DEVICE OF DYNAMICALLY ADJUSTING THE REFRESH RATE OF A DISPLAY

(71) Applicants: National Taiwan University, Taipei (TW); MediaTek Inc., Hsinchu City (TW)

(72) Inventors: Chung-Ta KING, Hsinchu (TW); Bhaskar DAS, Birbhum (IN)

(21) Appl. No.: 15/621,813

(22) Filed: Jun. 13, 2017

Related U.S. Application Data
(60) Provisional application No. 62/375,450, filed on Aug. 16, 2016.

(51) Int. Cl. G09G 3/20; G01P 15/18

(52) U.S. Cl. CPC G09G 3/2096; G09G 2340/0435; G09G 2330/021; G01P 15/18

(57) ABSTRACT

The present invention relates to methods, electronic devices, and computer-readable media of dynamically adjusting a refresh rate of an electronic device's display. The display is refreshable at one of various refresh rates. The method includes: determine a shaking degree of the electronic device; select one of the refresh rates based on the shaking degree; refresh the display at the selected refresh rate. By applying the present invention, the power consumption of the electronic device can be reduced and meanwhile maintain the user's viewing experience.

### CROSS-REFERENCE TO RELATED APPLICATIONS

The present application claims the benefit of priority of U.S. Provisional Patent Application No. 62/375,450, entitled “Dynamic Display Adjustment Based on Stillness of Device,” filed Aug. 16, 2016, which is incorporated herein by reference for all purposes.

### FIELD OF THE INVENTION

The present invention relates to methods, non-transitory computer readable media, and electronic devices of dynamically adjusting the refresh rate of a display in an electronic device, and more particularly, to adjust the refresh rate in response to the electronic device's shaking degree.

### BACKGROUND OF THE INVENTION

Images displayed on a monitor of an electronic device are refreshed periodically. The rate of changing one image to another is the so-called “refresh rate” (or “frame rate”). A conventional monitor displays 60 frames per second, i.e. that is, the monitor's refresh rate is 60 Hz, so that human eyes can accommodate to it. Current monitors are refreshable at a higher rate, such as 120 Hz, 240 Hz, etc. A higher refresh rate is beneficial to contents like video games, movies and video streaming because they can be displayed more smoothly and user's viewing experience may therefore be enhanced. However, a higher refresh rate renders a higher power consumption. Given an electronic device is expected to perform plenty functions and its battery capacity is limited, it gets more and more important to reduce the overall power consumption of the electronic device.

There are many discussions about how to adjust a display's refresh rate. US Pat. Appl. No. US2013/0328845 to Pylappan et al. describes a method to adjust a display's refresh rate based on whether the data displayed thereon is dynamic. U.S. Pat. No. 8,225,229 to Thorn et al. discloses a method of adjusting the refresh rate by eye tracking. US Pat. Appl. No. US2014/0307166 to Glen proposes an image rendering unit (IRU) which determines the dynamic frame rate capabilities (DFRCs) of a display and an image frame rate of content to be displayed. The DFRCs are stored in a storage device associated with the IRU. Based on the DFRCs and the image frame rate for the content, the IRU determines an updated frame rate and therefore provides the content to the display at the updated frame rate. When control of power consumption is desired, the frame rate is set to default. US Pat. Appl. No. US2013/0257752 to Tripathi et al. discloses a display which refresh rate is adjusted in response to information associated with the type of content to be displayed and user-input signals, etc.

To sum up, it has been widely accepted by the above discussions that if an image to be displayed is still, there is no need to refresh the display at a very high refresh rate. In other words, by determining whether the content to be displayed is dynamic or still to adjust the refresh rate, the power can be saved. This has been the most commonly seen way to solve the power consumption issue caused by displays.

### SUMMARY OF THE INVENTION

The invention disclosed herein describes a method of dynamically adjusting a refresh rate of an electronic device's display at one of a plurality of refresh rates. The method may include determining a shaking degree of the electronic device, and selecting one of the refresh rates based upon the shaking degree to refresh the display.

The method discussed in the invention can be instructed by computer programs. The programs/codes/instructions can be stored in any computer readable media and executable by a processor. Thus, the invention disclosed herein further describes a tangible, non-transitory computer-readable medium having stored therein instructions, that when executed by an electronic device with a processor, cause the electronic device to refresh its display at one of a plurality of refresh rates. The medium may further comprise instructions to determine a shaking degree of the electronic device; and select one of the refresh rates based on the shaking degree to refresh the display.

The electronic device of the invention describes a display refreshable at one of a plurality refresh rates. The electronic device may further include a sensor to sense a shaking degree of the electronic device; a processor, coupled to the sensor, to select one of the shaking rates based on the shaking degree; and a controller, coupled to the processor and the display, to refresh the display at the selected refresh rate.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 is a block diagram of an illustrative electronic device having a display with variable refresh rates in accordance with an embodiment of the present invention.

FIG. 2 is a flow chart of illustrative steps involved in dynamically adjusting the refresh rate of a display in an electronic device in response to the electronic device's shaking degree in accordance with an embodiment of the present invention.

FIG. 3 is another block diagram of an illustrative electronic device having a display with variable refresh rates in accordance with an embodiment of the present invention.

FIG. 4 is yet a flow chart of illustrative steps involved in dynamically adjusting the refresh rate of a display in an electronic device in response to the electronic device's shaking degree in accordance with an embodiment of the present invention.

FIG. 5 is another flow chart of illustrative steps involved in dynamically adjusting the refresh rate of a display in an electronic device in response to the electronic device's shaking degree in accordance with an embodiment of the present invention.

FIG. 6 is a further flow chart of illustrative steps involved in dynamically adjusting the refresh rate of a display in an electronic device in response to the electronic device's shaking degree in accordance with an embodiment of the present invention.

### DETAILED DESCRIPTION OF THE INVENTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

The inventors of the present invention observe that a user can be more tolerant to a lower display quality while he/she is moving and his/her electronic device is shaking. On the other hand, if the user is motionless, for instance, when he/she stands or sits, the user will expect a higher display quality from his/her electronic device. The inventors of the invention therefore provide an unique technique to update a display's refresh rate in response to the shaking degree of an electronic device. By applying the present invention, the power consumption of the electronic device will not only reduce but the user's viewing experience can be maintained.

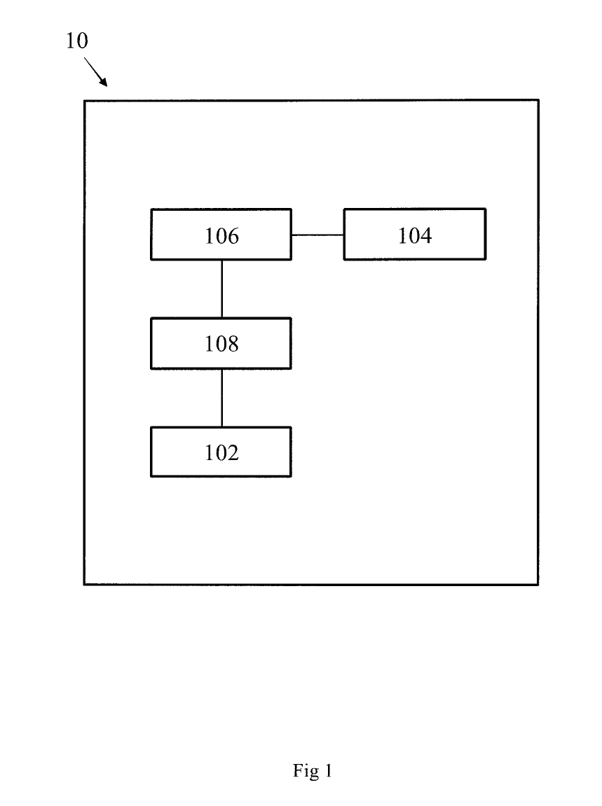

An illustrative electronic device in accordance with an embodiment of the present invention is depicted in FIG. 1. As shown the electronic device 10 may include a display such as display 102, a sensor such as sensor 104, one or more processors such as processor 106, and a controller such as controller 108. Processor 106 is coupled to sensor 104; controller 108 is coupled to processor 106 and display 102. Although they are not shown in FIG. 1, it should be understood by those skilled persons that electronic device 10 may further include hardware (e.g. any circuitries), software (e.g. any programs, codes and/or instructions stored in any kind of tangible and non-transitory computer-readable media), or any combinations of the two. It should also be noted that FIG. 1 is a mere illustration showing one embodiment of the present invention. The components therein can be of any kind. For instance, processor 106 can be any kind of standalone processing units such as graphic processing units (GPUs) and central processing units (CPUs). Alternatively, processor 106 can be any kind of integrated processing units such as system-on-chips (SOCs); or it can be entirely or partially integrated into the other components inside electronic device 10. Additionally, the components depicted in FIG. 1 can also be entirely or partially implemented either by programs/codes/instructions stored in tangible and non-transitory computer-readable media (such as software or firmware), by hardware, or by any combinations of the above.

Electronic device 10 may be a mobile phone, a tablet, a laptop or any devices of the same kind. Display 102 may be any sort of devices capable of displaying contents. For instance, a liquid crystal display (LCD) or an organic light-emitting diode (OLED) display, etc. Sensor 104 can be any types of sensors (such as an accelerometer, a gyroscope, an e-compass, or any combinations of the above) serving to sense the shaking degree of electronic device 10. Processor 106 and/or other processing units are capable of processing and calculating data and executing instructions. Controller 108 manages display 102 dynamically.

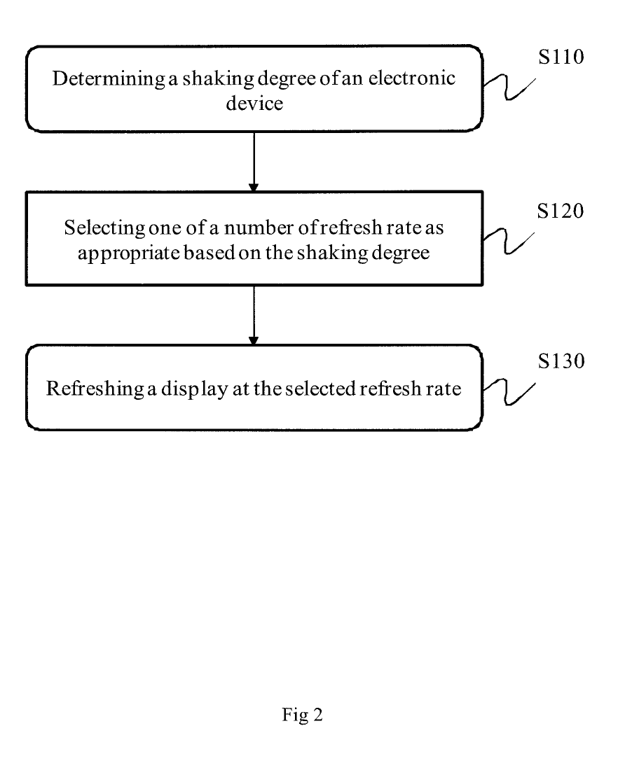

FIG. 2 shows illustrative steps involved in dynamically adjusting the refresh rate of a display such as display 102 in an electronic device such as electronic device 10 in response to the electronic device's shaking degree. Display 102 is refreshable at a variable refresh rate. As shown, a sensor such as sensor 104 may sense the shaking degree of an electronic device such as electronic device 10 at step S110. At step S120, a processor such as processor 106 may select one of a plurality of refresh rates as appropriate. At step S130, a controller such as controller 108 may update the refresh rate of display 102 at the selected refresh rate.

The shaking degree of electronic device 10 may be determined by data of acceleration, velocity, displacement, triangular coordinates etc. collected by sensor 104. For instance, assuming a triaxial accelerometer capable of measuring the accelerations in the three orthogonal directions—X, Y, and Z per 100 milliseconds is adopted to collect relevant data. The shaking degree of electronic device 10 can be obtained by the following calculations. First of all, the ten acceleration values measured in one second are summed to calculate an average acceleration value or a standard deviation value in each of the three orthogonal directions. The shaking degree then is defined as the average value of the two maximum values from the three orthogonal directions. There are various ways to calculate the shaking degree of an electronic device. In an alternative embodiment, the shaking degree may be defined by displacement and/or changes of coordinates. The present invention does not intend to limit the way in which the shaking degree should be determined. In the present invention, the shaking degree of an electronic device can be calculated based on data collected by any kind of sensor such of sensor 104 so long as the date is able to represent how serious an electronic device such as electronic device 10 is shaking.

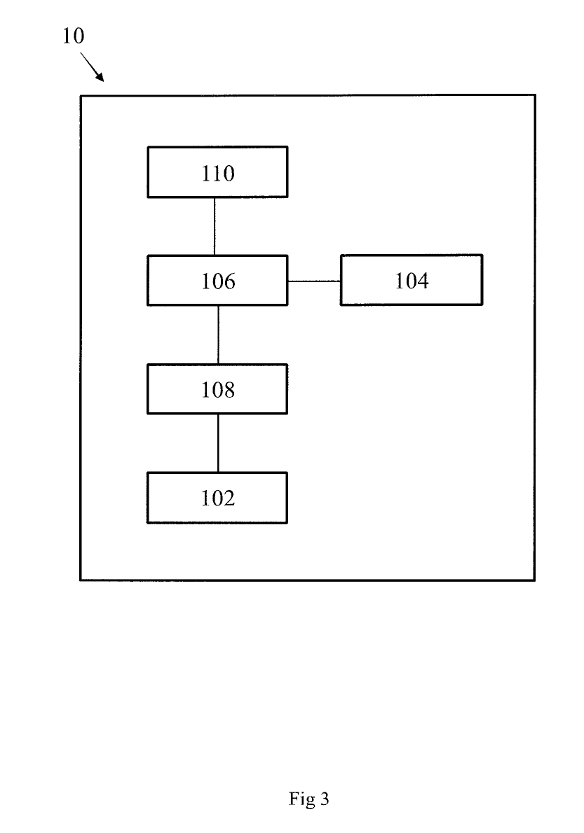

Another illustrative electronic device in accordance with an embodiment of the present invention is further depicted in FIG. 3. In additional to the components illustrated in FIG. 1, electronic device 10 shown in FIG. 3 may further include a memory such as memory 110. A processor such as processor 106 and/or any other data processing units may execute codes/instructions or process data stored in the memory or process data stored therein. A memory such as memory 110 in FIG. 3 may be one or any combinations of the following: a read-only memory (ROM), a programmable read-only memory (PROM), an erasable programmable read-only memory (EPROM), an electrically-erasable programmable read-only memory (EEPROM), a hard disk, a floppy disk, a CD-ROM, a digital video disk (DVD), a flash memory, a magneto-optical disk or any other non-volatile media which can be used to store the desired electrical data (such as codes/instructions) and which can be accessed by computers.

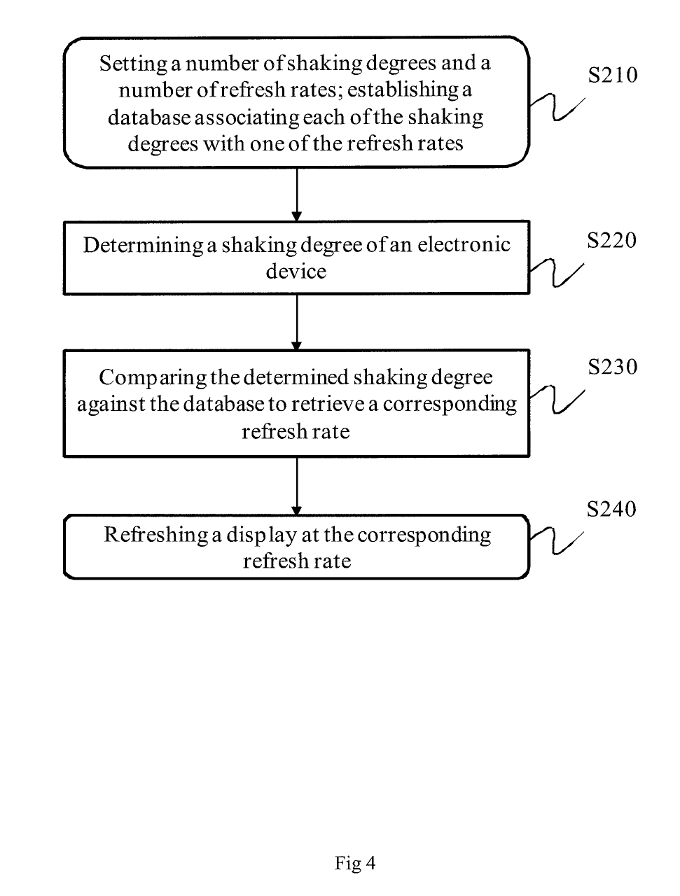

A memory such as memory 110 can store a database associating shaking degrees with refresh rates. In one embodiment, a processor such as processor 106 compares the shaking degree of an electronic device such as electronic device 10 sensed by a sensor such as sensor 104 against the database stored in a memory such as memory 110 to retrieve an appropriate refresh rate. More precisely, as illustrated in FIG. 4, a number of shaking degrees and a number of refresh rates are set in advance at step S210. The database associating the shaking degrees and the refresh rates is also established (also at step S210). In the database, each one of the shaking degrees is corresponding to one of the refresh rates. For instance, a low shaking degree may correspond to a refresh rate at 240 Hz, a middle shaking degree may correspond to a refresh rate at 120 Hz, while a high shaking degree may correspond to a refresh rate at 60 Hz. That is, if sensor 104 senses that the shaking degree of electronic device is low (e.g. at step S220), processor 106 selects 240 Hz as the refresh rate accordingly (e.g. at steps S230 and S240).

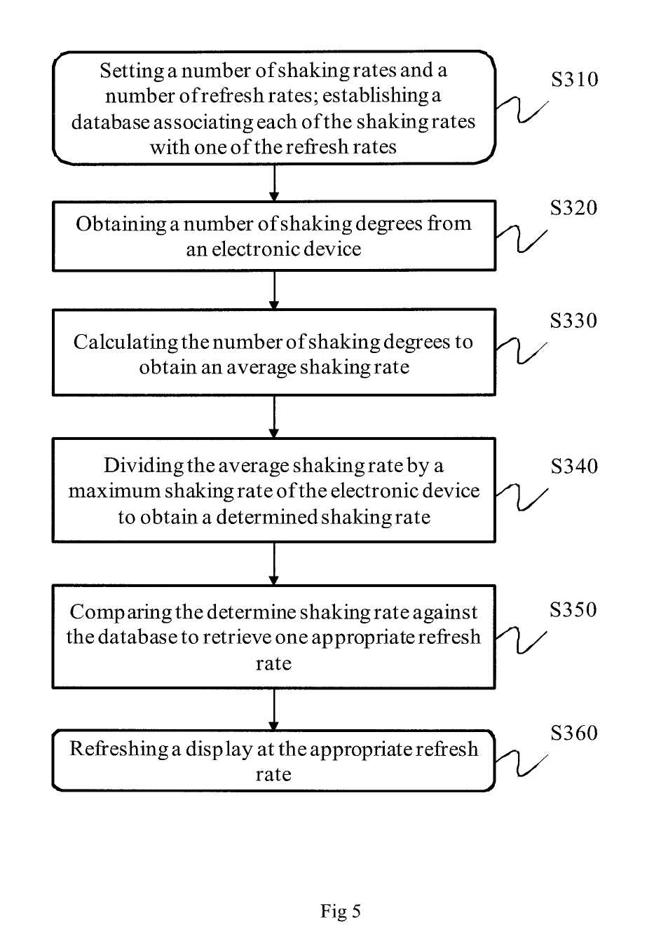

FIG. 5 shows an alternative steps to dynamically adjust the refresh rate of a display in an electronic device in response to the electronic device's shaking degree. First of all, a number of shaking rates and a number of refresh rates are set in advance at step S310. The database associating the shaking rates and the refresh rates is also established (also at step S310). In one embodiment, sensor 104 senses a number of shaking degrees from electronic device 10 at step S320. At step S330, processor 106 calculates the shaking degrees to obtain an average shaking rate. At step S340, processor 106 further divides the average shaking rate by a maximum shaking rate electronic device 10 could possibly achieve. The result therefore obtained is defined as a determined shaking rate scaling from 0 to 1. Similarly, processor 106 compares the determined shaking rate against the database to retrieve an appropriate refresh rate at step S350. For instance, if the determined shaking rate is in-between 0 to 0.4, a refresh rate at 60 Hz is selected; if the determined shaking rate falls within 0.4 to 0.75, a refresh rate at 120 Hz is selected; while if the determined shaking rate is from 0.75 to 1, a refresh rate at 240 Hz is selected. Lastly, display 102 is refreshed at the selected refresh rate at step S360.

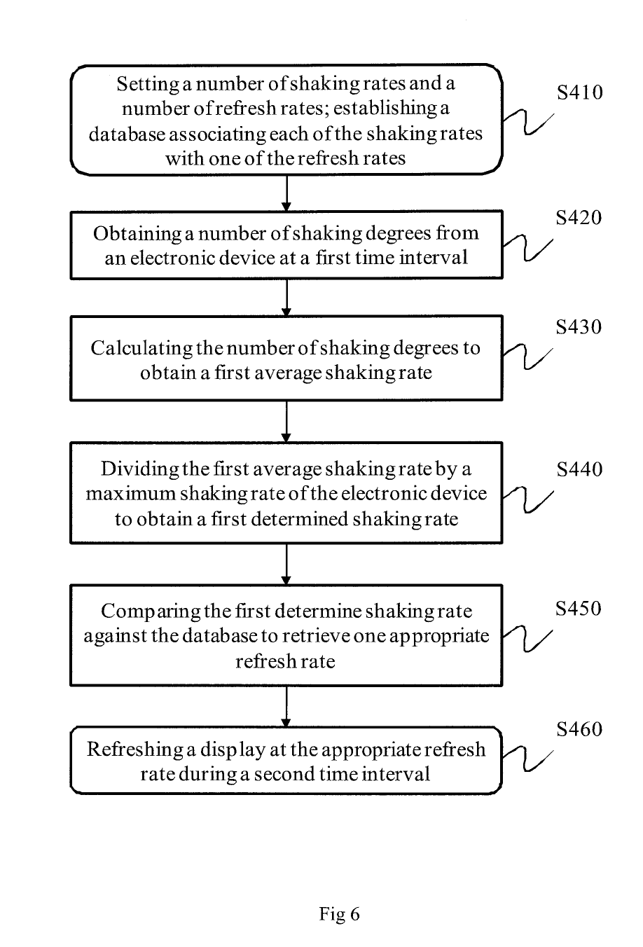

FIG. 6 further illustrates another alternative steps to dynamically adjust the refresh rate of a display in an electronic device in response to the electronic device's shaking degree. Similarly, a number of shaking rates and a number of refresh rates are set in advance at step S410. The database associating the shaking rates and the refresh rates is also established (also at step S410). In one embodiment, sensor 104 senses a number of shaking degrees of electronic device 10 within a first time interval at step S420. Processor 106 determines a first average shaking rate at the first time interval at step S430 based on the shaking degrees. Following that, processor 106 further divides the first average shaking rate by a maximum shaking rate electronic device 10 could possibly achieve at step S440. The result therefore obtained is defined as a first determined shaking rate. At step S450, processor 106 compares the first determined shaking rate against a database associating a number of shaking rates with a number of refresh rates to retrieve an appropriate refresh rate. Display 102 is then refreshed at the appropriate refresh rate during a second time interval at step S460. For example, assuming the database is identical to the database described in FIG. 5. Sensor 104 senses a number of shaking degrees of electronic device during the first minute, i.e. the first time interval. Based on the shaking degrees, processor 16 calculates that the first determined shaking rate is 0.5. Display 102 is then refreshed at 120 Hz during the next five minutes, i.e. the second time interval.

The embodiments disclosed in the present invention may be applicable to computer or microprocessor systems. The methods and/or steps disclosed therein may be implemented by computer programs/codes/instructions stored in, for instance but not limited to, any sort of computer-readable media, such as a hard disk, a floppy disk, a ZIP, a MO, an IC chip, a random-access memory, or any other media familiar by those skilled in the art. When a computer is executing the embodiments of the present invention, the relevant computer programs/codes/instructions are loaded into a memory for the computer to process and execute accordingly.

The above-described embodiments of the invention are presented for purposes of illustration and not of limitation. Of course, those skilled in the art will recognize many modifications may be made to this configuration without departing from the scope of the disclosed aspects.

What is claimed is:

1. A method of dynamically adjusting a refresh rate of an electronic device's display at one of a plurality of refresh rates, comprising:
determining a shaking degree of the electronic device; and
selecting one of the refresh rates based upon the shaking degree to refresh the display.

2. The method of claim 1, furthering comprising: setting a plurality of shaking degrees and the refresh rates, wherein each of the shaking degrees is associated with one of the refresh rates, and the refresh rate selected to refresh the display is determined based on the corresponding shaking degree.

3. The method of claim 1, further comprising:
setting a plurality of set shaking rates associating with the refresh rates;
obtaining a plurality of shaking degrees from the electronic device;
calculating an average shaking rate based on the shaking degrees;
dividing the average shaking rate by a maximum shaking rate of the electronic device to obtain a determined shaking rate; and
comparing the determined shaking rate against the set shaking rates to select an appropriate refresh rate out of the set shaking rates.

4. The method of claim 3, wherein the method is performed at a first time interval and the display is refreshed at the appropriate refresh rate during a second time interval.

5. A tangible, non-transitory computer readable medium having stored therein instructions, that when executed by an electronic device with a processor, cause the electronic device to refresh a display, refreshable at one of a plurality of refresh rates, in response to the electronic device's shaking degree, comprising
determining a shaking degree of the electronic device; and
selecting one of the refresh rates based on the shaking degree to refresh the display.

6. The medium of claim 5, further comprising: setting a plurality of shaking degrees and the refresh rates, wherein each of the shaking degrees is associated with one of the refresh rates, and the refresh rate selected to refresh the display is determined based on the corresponding shaking degree.

7. The medium of claim 5, further comprising:
setting a plurality of set shaking rates associating with the refresh rates;
obtaining a plurality of shaking degrees from the electronic device;
calculating an average shaking rates based on the shaking degrees;
dividing the average shaking rate by a maximum shaking rate of the electronic device to obtain a determined shaking rate; and
comparing the determined shaking rate against the set shaking rates ranges to select an appropriate refresh rate out of the set shaking rates.

8. The medium of claim 7, wherein the steps are performed at a first time interval and the display is refreshed at the appropriate refresh rate during a second time interval.

9. An electronic device, comprising:
a display refreshable at one of a plurality refresh rates;
a sensor configured to sense a shaking degree of the electronic device;
a processor, coupled to the sensor, configured to select one of the shaking rates based on the shaking degree; and
a controller, coupled to the processor and the display, configured to refresh the display at the selected refresh rate.

10. The electronic device of claim 9, further comprising a memory to store a database associating the shaking degree with one of the refresh rates, wherein the processor compares the shaking degree sensed by the sensor against the database to retrieve an appropriate shaking rate to refresh the display.
